(19) United States
(12) Patent Application Publication
(10) Pub. No.: US 2010/0023378 A1
(43) Pub. Date: Jan. 28, 2010

(54) Process for quantifying consumer or voter values

(76) Inventor: Diwakaran Avinash Ratnam, Woodbury, MN (US)

Correspondence Address: Mark Edward Reeves, 238 Dunbar Way, Mahtomedi, MN, 55115-2814, US

(21) Appl. No.: 12/432,746

(22) Filed: Apr. 29, 2009

Related U.S. Application Data
(60) Provisional application No. 61/048,602, filed on Apr. 29, 2008.

(51) Int. Cl. G06Q 10/00

(52) U.S. Cl. 705/10

(57) ABSTRACT

A method for quantifying a participant's values and opinions comprising the steps of: presenting a list of qualities pertaining to a set of alternatives to the participant, the participant ranking the importance of said qualities, presenting a list of alternatives to the participant, the participant rating the alternatives on performance or possession of said qualities, transforming the data so as to quantitatively compare the alternatives.

### CROSS REFERENCE TO RELATED APPLICATIONS

This application claims the benefit of U.S. Provisional Patent Application No. 61/048,602, filed Apr. 29, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of data processing and more specifically to a process for quantifying consumer or voter values. Opinion polls provide data on the consumers' or voters' opinions but not on the reasons behind those opinions. This invention gives insight to those reasons.

### BRIEF SUMMARY OF THE INVENTION

The primary object of the invention is To quantify the values behind voter decisions.

Another object of the invention is to quantify the values behind consumer decisions.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for quantifying consumer or voter values comprising the steps of: presenting and/or generating a list of qualities pertinent to performance of a job or a consumer product or service, ranking importance of said qualities, rating candidates or consumer alternatives on performance of said qualities, and analyzing data input during said ranking and rating steps.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the steps perceived by the participant.

FIG. 2 is a flow chart of the optional step of control of access to the poll.

FIG. 3A is a flow chart of the presenting the qualities to be ranked.

FIG. 3B is a flow chart of the step of processing qualities entered by the participant.

FIGS. 4A and 4B are examples of assigning values to the qualities on the presented or generated list.

FIGS. 5A, 5B, 5C, and 5D are examples of assigning values indicating the performance or possession of the ranked qualities by alternatives.

FIG. 6 is an example of analysis of the data input.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Opinion polls have been used extensively for determining the opinions of consumers and voters. However, knowing the opinions of consumers or voters may not provide enough information to be able make changes to a product, service, or campaign promise to change the consumers' or voters' opinions.

For the purposes of this application, a consumer is defined as a person who acquires a product or utilizes a service. These products may or may not be purchased items. For example, the service could be computer assistance provided by the internal Informational Technology Department of a corporation. The product could be a raw material for a manufacturing process. The consumer is a person who has a pertinent opinion relating to the product or service.

A voter is defined as one who will cast a vote to decide a course of action. For example, it could be a voter in a political election whose vote will help decide who will lead the government. The voter could indicate in any number of ways preference for a particular business decision the company may be facing. The term candidate is defined as an option being considered by the voters. The term candidate is not constrained to be a person.

For the purposes of this application, the term participant is defined as the consumer or voter who is providing information about their values, opinions, or perceptions.

For the purposes of this application, the term pollster is defined as a person, group of persons, who define how the poll is to be taken (i.e. subject, qualities to be presented, candidates to be evaluated, logic for dynamic selections of qualities and candidates to be presented, analysis to be done, etc.) or administer the poll.

For the purposes of this application, the term alternative (noun) is defined as one of two or more things, courses, or propositions to be chosen as per Merriam-Webster Online dictionary definition 2a. For the purposes of this application, an alternative can be real or hypothetical. Some examples include (but are not limited to) products, processes, people, business methods and plans, and political candidates. For example, a poll on wood working tools may have generic alternatives of corded drills and cordless drills, or may have more specific alternatives such as DeWalt cordless 18 volt XRP drill, Makita Lithium Ion 18 volt cordless drill, and Metabo PowerMaxx cordless drill. Business methods or plans of action may be alternatives. For example, a decision about business strategy may have alternatives of being the market leader, being a fast follower, and being the low cost supplier. Political candidates may be alternatives. Some illustrative (but not limiting) examples of people alternatives are people applying for a job, people being consider for a date in a matchmaking setting, and groups of people being considered for a targeted marketing campaign.

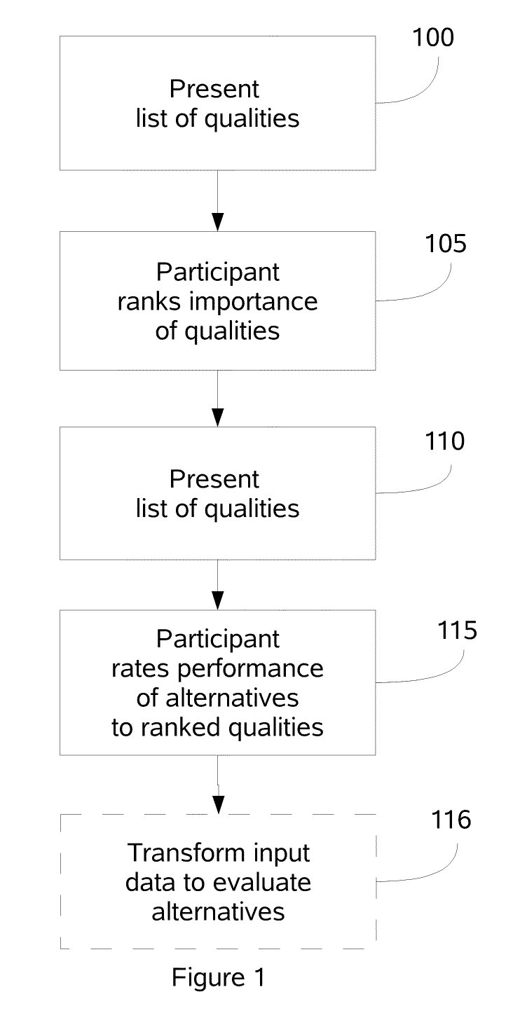

A summary of steps of the taking of this poll as seen by the participant are shown in FIG. 1. A list of qualities related to the alternatives under consideration are presented to the participant (100). The participant then ranks those qualities in order of importance (105). A list of alternatives is then presented to the participant (110). The participant then evaluates how the alternatives under consideration possess or perform or illustrate the qualities on the list (115). The transforming of the input ranking and rating data (116) may or may not be shown to the participant.

The performance of these steps may be different in different devices. Polls of this nature may be conducted using a stand-alone computer, a client-server system, or an internet terminal connected to a server.

In some embodiments the device for performing the steps of this method is defined as a stand-alone computer. This stand-alone computer has means for displaying information (a display), means for storing computer readable instructions (memory), means for storing data (memory), means for inputing data (keyboard, touchscreen, mouse, voice recognition devices, or other devices commonly used to interact with a computer) means for processing computer readable instructions (central processing unit—CPU), and means for transferring raw data and/or transformed data (display, wireless network connection, physical port such as but not limited to a serial, ethernet, usb, parallel, Firewire™). Some embodiments utilize the components and software similar or identical to those utilized in a Windows™ or Apple™ based computer. Other embodiments utilize components and software based on the Palm™ handheld devices. Other embodiments utilize components and operating software assembled and programmed per unique specifications. Some embodiments take the form of a handheld device. Some embodiments take the form of a kiosk.

In some embodiments the device used to perform the steps in the polling process is a client-server system. In such a system the components required to perform the steps may be distributed between the client computer and the server. The client must have at least a display, a way of interacting with the participant (typically a keyboard or mouse or voice recognition), means for storing and executing computer readable instructions, and means for communicating with the server. Either the server or the client may store the computer based instructions, the data collected, and any transformed data.

In some embodiments the device used to perform the steps in the polling process is a internet accessible device connected via the internet to a server. Examples of internet accessible devices include but are not limited to personal computers, smart phones, netbooks, and gaming systems. All or a portion of the computer readable instructions may be downloaded to the internet accessible device. The polling process may also be performed as a web application run through a browser.

### Ranking the Qualities

For this application the phrase ranking the qualities is defined to mean the assignment of a numerical value to each of the qualities presented indicating the importance the participant places on that quality in view of the alternatives to be considered. These values may be set directly by the participant or may be calculated by weighting formulas where the participant indicates a non numerical rank of importance.

The participant is presented a list of qualities pertaining to the alternatives to be considered. For this application the term presents when used in reference to the ranking step is defined to include any computer operations required to both display the qualities on a display and provide means for the participant to indicate in a computer readable format a ranking of the qualities presented.

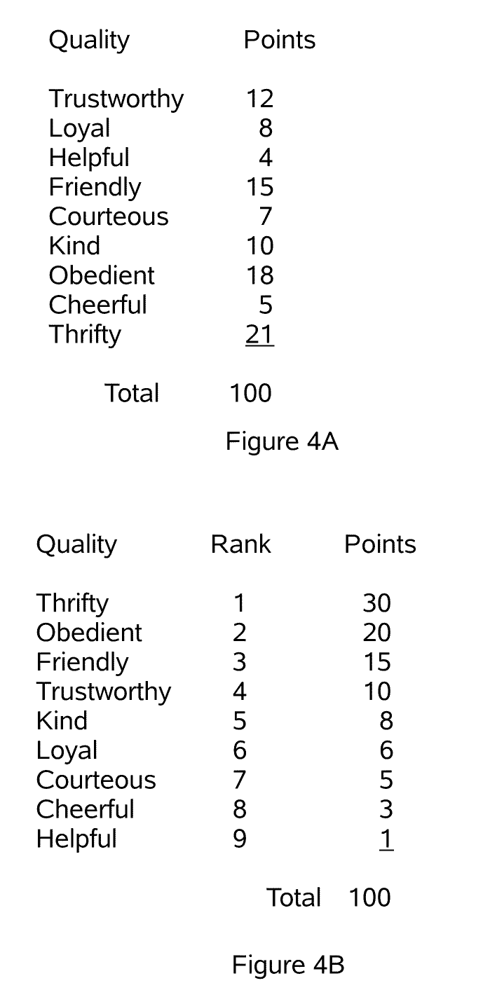

In one embodiment the participant assigns a point value to each of the qualities (FIG. 4A). The total number of points must total a predetermined amount (for example 100 points).

In another embodiment, the participant ranks the qualities in order of importance (FIG. 4B). A corresponding point value is assigned, the value being set by the pollster. Methods such as pairwise comparison may be utilized to aid in establishing the ranking.

In another embodiment, the participant indicates the value of the quality by assigning or indicating a value on a scale (for example a value of 7 on a scale of 1 to 10 with 10 being high).

When performing the ranking process, steps to make the process more user friendly may be incorporated. Such steps would include but not be limited to steps of verifying all qualities have been ranked and where applicable the sum of the points assigned equals the designated total.

Various graphical interfaces may also be incorporated. For example, when distributing a designated number of points to the various qualities, a bar graph could be incorporated showing the value each quality has been assigned. Adjusting the length of the bar of any one quality would show the change to the total points assigned or yet to be assigned. The process would not be completed until all the designated points have been assigned and no more.

Graphical interfaces for setting the rank order could include dragging and dropping the qualities to place them in order.

### Optional Steps in Presenting Qualities

While some polls may keep the qualities and alternatives the same for participants, in some embodiments steps may be incorporated to dynamically vary the polling process.

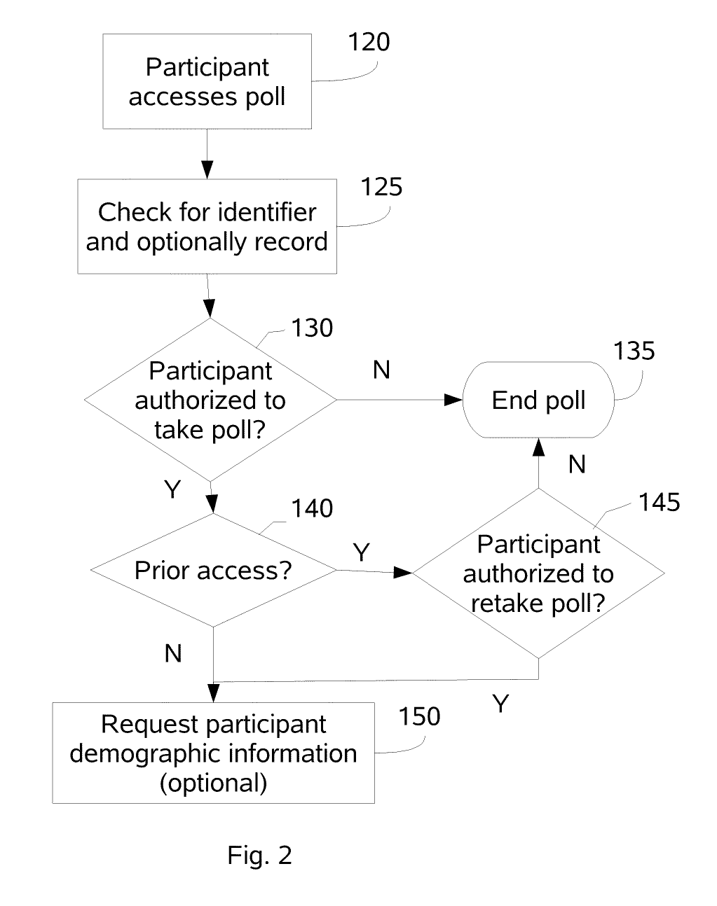

Personal demographic or other information may be collected from the participant (FIG. 2, 150). This information could be entered by the participant or collected based on accessible information such as an IP address. Demographic data may be entered or correlated to previous entries. This personal demographic data may be entered over the internet by using, for example (but not limited to) a computer input device such as a keyboard or pointing device. Client-server systems and stand-alone computers may also incorporate a voice recognition system, a bio-metric scan, an identity document swipe, or a RFID or other contactless tag.

The qualities to be presented to the participant to rank may be the same for all participants or may be varied by numerous means. Based on information about the participant (either entered by the participant or collected by accessible means) a subset of all possible qualities may be presented. For example, in a national election poll, for an IP address in Arizona, qualities related to illegal immigration may be presented while for an IP address in Ohio, qualities related to restricting importation of goods may be presented. In a poll about a sport utility vehicle, a consumer who has indicated participating in sports such as backpacking or rock climbing may be presented with qualities related to off road performance while another consumer who has indicated being a “soccer mom” may be presented with qualities related to convenience and safety.

In another embodiment, a generalized list of qualities is presented to all participants the first time they participate in that poll. Subsequently (either at the completion of the poll the first time or during a subsequent accessing the poll) the participants could again take the poll but with different or more specific qualities. For example, the general qualities for a candidate for elected office may include positions related to taxes, health care reform, abortion, national security, and immigration. Once the poll is completed, the participant could be offered the opportunity to take the poll again with the qualities presented based on the highest ranked quality or qualities. If health care was a top ranked quality, the second qualities could include support for universal health care, support for health care savings accounts, and support for physician assisted suicide.

In another embodiment, a participant accessing the poll more than once may be allowed to take the same poll (same qualities and candidates). The data may be processed by the pollster in a number of ways. A limited number of duplicate results may be considered valid to allow for multiple unique participants utilizing a single computer or IP address. Beyond a specified number may be interpreted as someone trying to bias the results allowing the pollster to take appropriate actions to limit or account for the attempts to bias the results. Non-identical results (or dissimilar enough by some criteria such as percentage or different on a number of key points) may be included as either different unique participants on the same computer or IP address or a change to the participant's valuation of the qualities and/or change in perception of the performance of the product or candidate to one or more qualities. In one embodiment the changes in a participant's values and perceptions are recorded for analysis as to causes for the changes.

In another embodiment, a subset of the list of the qualities is presented to minimize the number of qualities each participant must rank. The selection of the qualities could be uniform in nature such as a random selection or based on a design of experiments. For example, if the number of relevant qualities were 15 but it is felt that participants would find it too difficult to rank that many qualities, for each participant a smaller number of qualities, for example 7, could be selected at random from the complete set of qualities and presented. Instead of randomly selecting the qualities to be presented, the selection may be done using a statistical process or designed experiment. The selection may also be biased to more frequently contain certain qualities based on some criteria such as importance to the pollster or a need for more knowledge regarding certain qualities.

In another embodiment the criteria for selection of the qualities to be presented may be dynamic, changing based on the results of other participants. As one or more qualities are identified as more important or of increasing importance, the qualities presented could include those qualities more frequently or be supplemented or replaced by more specific qualities. For example, initial poll results may indicate that consumers giving opinions on a new product may place a higher value on the quality “Appearance” as opposed to the quality “Additional Features” or “Cost”. The qualities presented could be changed to gain more specific information on “Appearance” by presenting qualities such as “Color”, “Texture”, and “Design”.

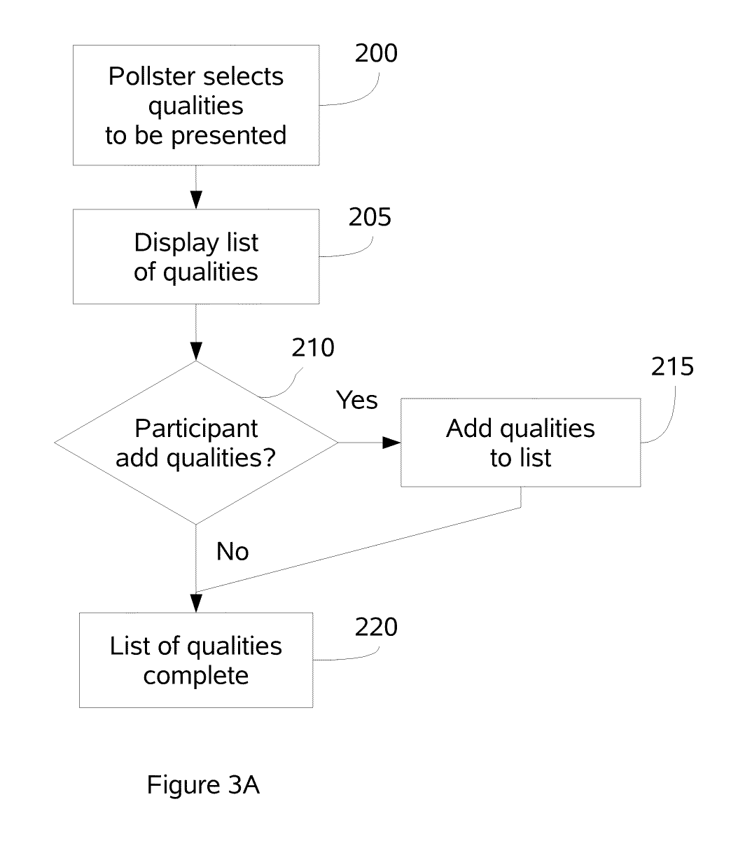

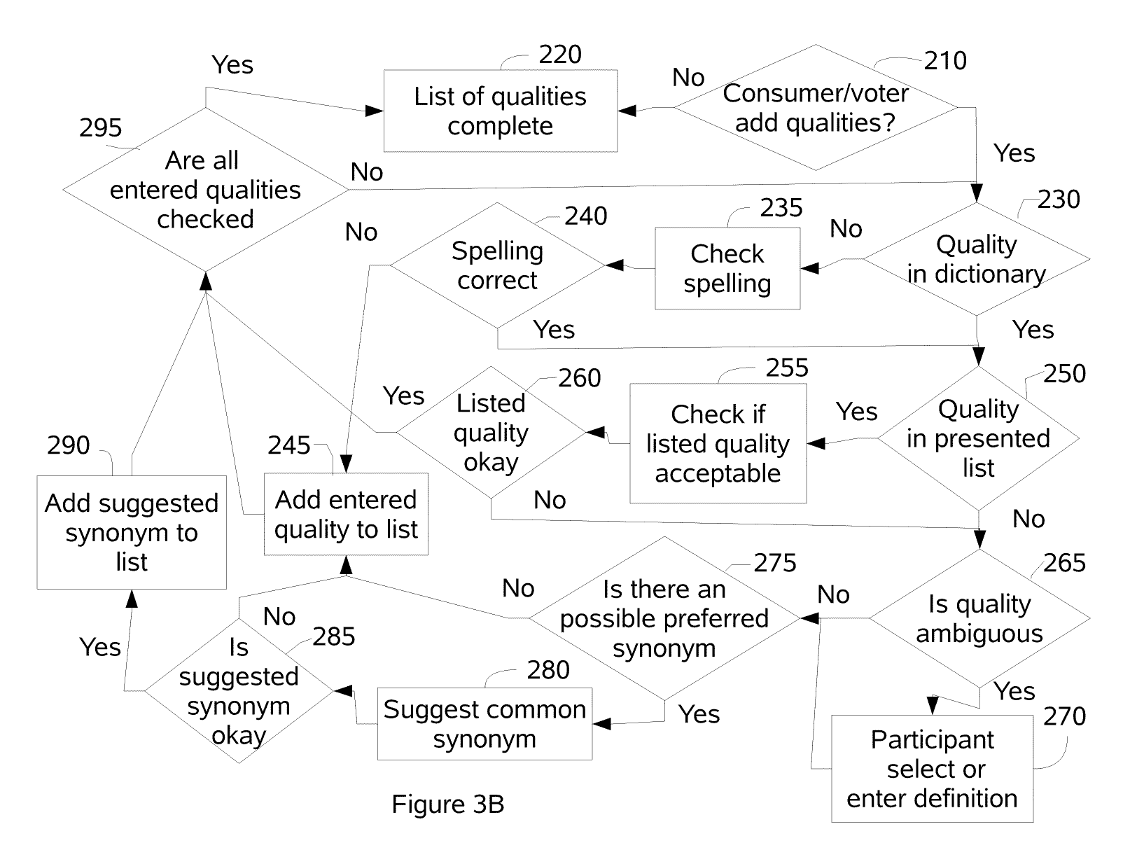

In one embodiment, shown in FIG. 3, the step of presenting/generating the list of qualities may be done by solely by the pollster or it may allow the participant the ability to add qualities not presented by the pollster. These qualities added by the participant may further processed as shown in FIG. 3B. First, a spell check of the entered qualities may be done to assure the words entered are what was intended to be entered (230). Should the entered quality not be found in the accessed dictionary or dictionaries (either paper or electronic), the participant who entered it would be asked to check the spelling. If the participant does not change the spelling (240), the quality would be added to the list as the participant entered it (245). If the quality is changed to words known in the accessed dictionary or dictionaries, the process would continue to the next step.

Entered qualities can be compared to the presented list (250) to check if the entered qualities were already present but overlooked by the participant. If the entered quality appears to be the same or similar to a quality on the presented list, the participant would be asked to confirm that the entered quality was the listed quality (255) (260). If the qualities are the same, the entered quality would not be entered and the process would check for additional entered qualities (295). If the participant indicates the entered quality is not the same as the listed quality, the process proceeds to the next step.

Qualities entered by a participant may or may not be ambiguous. Entered qualities may be described in slang terms or idioms or words with special meanings when used in certain contexts. If there is uncertainty as to the meaning of the quality entered (265), various possible definitions may be suggested (270). The participant may select one or none of the definitions. If the quality entered is not ambiguous, the process continues to the next step.

Participants may enter different qualities that mean the same thing. For example different Participants could enter cute, pretty, and handsome. If these are not on the presented list, these qualities may be considered as unique qualities or it may be preferred to combine these under a common quality such as “attractive” or one of the entered qualities. If there is a preferred synonym found for an entered quality (275), it may be suggested to the participant (280). If the participant accepts the synonym (285), the synonym will be added to the list of qualities. If the participant does not accept the suggested synonym (285), the quality entered (or corrected for spelling or meaning) will be added to the list of qualities (245).

This process of checking the entered qualities will repeat for each entered quality (295), until the list of qualities to be ranked is complete (220).

Storing the Data from the Ranking Process

The values generated by the ranking process are stored on a computer readable medium. In the case of the stand-alone computer, it would be in a local memory device. In the client-server system, the data would could be stored on either the client computer or the server. In the internet based system, the data could be stored on the internet accessible device or may be stored on the server.

### Rating the Alternatives

For this application the phrase rating the alternatives is defined to mean the assignment of a numerical value to each quality/alternative pair indicating the possession or performance of the quality by the alternative as perceived by the participant. These values may be set directly by the participant or may be calculated by weighting formulas where the participant indicates a non numerical rank of importance.

The participant is presented a list of qualities and the alternatives to be considered. For this application the term presents when used in reference to the rating step is defined to include any computer operations required to both display the qualities and alternatives on a display and provide means for the participant to indicate in a computer readable format a rating of the performance or possession of the qualities by alternatives.

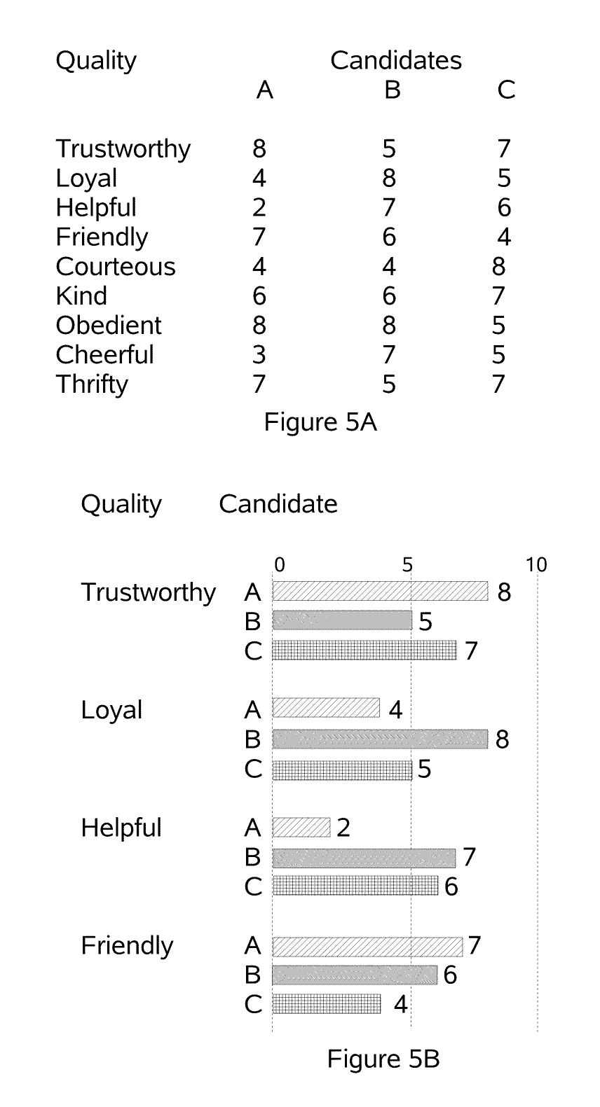

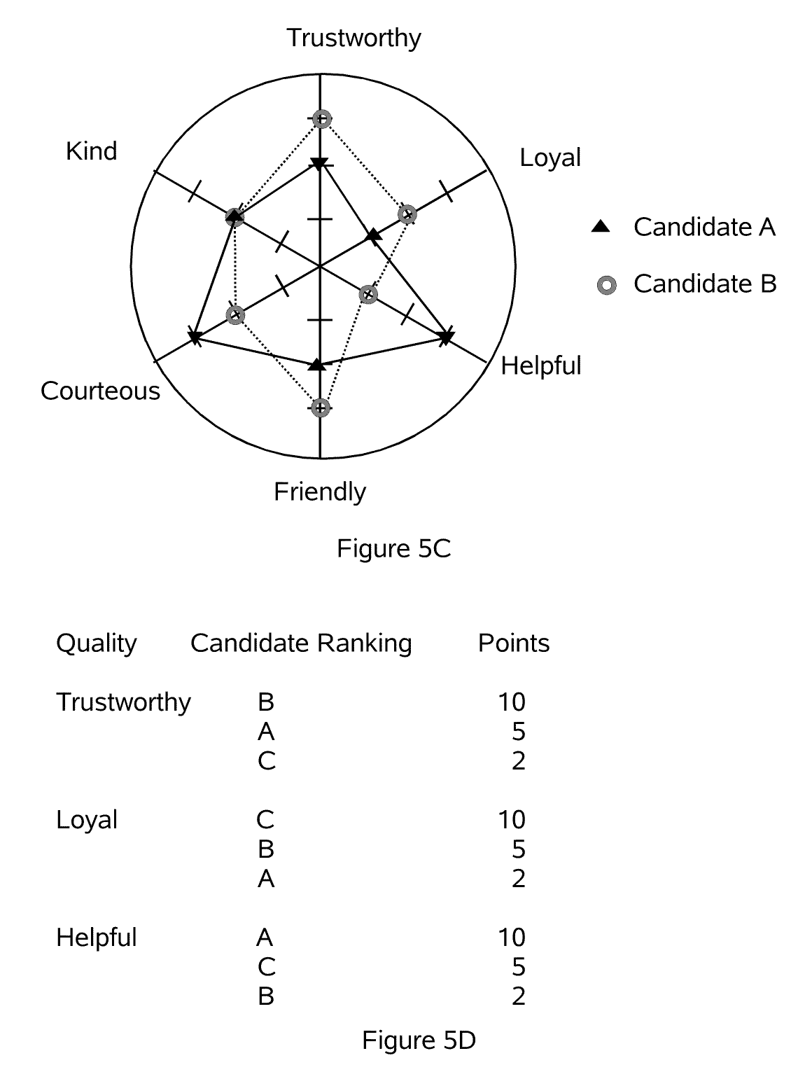

In one embodiment, the participant is presented with a list of the qualities and a column for each of the alternatives to be evaluated (FIG. 5A). The participant would enter a value for quality/alternative pair. In another embodiment, each quality is presented one at a time for evaluating the various alternatives.

The pollster may present a complete list of qualities as established in the previous steps or may elect to present only a subset of qualities to for alternative evaluation. The subset may be selected for a variety reasons. Some examples include (but are not limited to) only the top ranked qualities, only qualities that based on previous polls or current polling indicate a significant difference between alternatives, only qualities below a certain level of importance (to eliminate qualities that are expected qualities such as a product runs as intended), and qualities anticipated to have greater ability to impact the alternatives selection (based on potential to change either the perceived value of the quality or perceived alternatives performance of that quality).

The scale to indicate performance or possession of a quality may be a linear numeric scale. For example, a scale of 0-10 where 0 indicates the alternatives does not posses this quality at all, 10 indicates the alternative fully possesses that quality, and 5 indicates the alternative possesses 50% of that quality or possess that quality 50% of the time.

The values assigned may be on a sequential scale but with the possession of the quality not being linear. For example, 1 may indicate possession 50% of the time or less, 2 indicate possession 50-65% of the time, 3 indicate possession 65-80% of the time, 4 indicate possession 80-90% of the time, and 5 indicate possession 100% of the time.

The values for a quality/alternative pair could be indicated by a +, 0, or − (plus, zero, minus) or a ++, +, 0, −, −− (double plus, plus, zero, minus, double minus) with either linear or non-linear scales.

Scales (linear and non-linear) may use other indices for performance valuation. For example letters of the alphabet or colors could be used to indicate performance of a quality where the meaning of the letters or colors is obvious or otherwise indicated.

When performing this step graphical interface tools may be utilized for the participant to indicate candidate performance. Such tools could include sliding bars, drop down lists, dial indicators, and drag and drop of icons. Relative performance of the alternatives relative to each other may be indicated by a visual tool such as (but not limited to) a spider diagram, bar charts, line graphs (FIG. 5B and FIG. 5C).

In another embodiment (FIG. 5D), for a given quality, the participant does not assign a specific value to each alternative but instead places the alternatives in order of their possession of that quality. The pollster would assign a value to each quality/alternative pair based on the rank order indicated by the participant. For example, if a poll was evaluating three alternatives, for each quality the top ranked alternative might be given a value of 10, the second ranked alternative might be given a value of 5, and the lowest ranked alternative given a value of 2.

The selection and presentation of the alternatives to be evaluated may be controlled by the pollster. In one embodiment, the alternatives presented for evaluation are the same for every participant. In other embodiments the alternatives presented are dynamically selected in a random process. In other embodiments the alternatives presented are dynamically selected in a non-random process based on statistical principles such as (but not limited to) design of experiments.

In one embodiment the selection of alternatives to be presented is based on the participant's valuation of the qualities. While there are many ways to utilize the participant's valuation of the qualities, one illustrative example is out of a pool of several alternatives, only present candidates which based on past polling frequently have differences in the most important qualities of the participant. Another example would be to present alternatives which have based on past polling little differences in the qualities most important to the participant so as to focus on qualities of secondary importance to the participant.

In another embodiment, the participant may select from a list of alternatives which candidates to evaluate. For example, a poll on cordless electric drills may have 15 or more potential alternatives. A participant could select as few as one to evaluate based on their personal experience.

In another embodiment, the pollster may present alternatives to the participant to evaluate but then allow the participant to add or subtract alternatives. For example, in a political election, the two front runners may be presented by the pollster but the participant may add one or more other candidates to evaluate as well.

### Storing the Rating Values

The values generated by the rating process are stored on a computer readable medium. In embodiments using a stand-alone computer, it would be in a local memory device. In embodiments using a client-server system, the data would could be stored on either the client computer or the server. In embodiments using an internet based system, the data could be stored on the internet accessible device or may be stored on the server.

### Transforming the Data

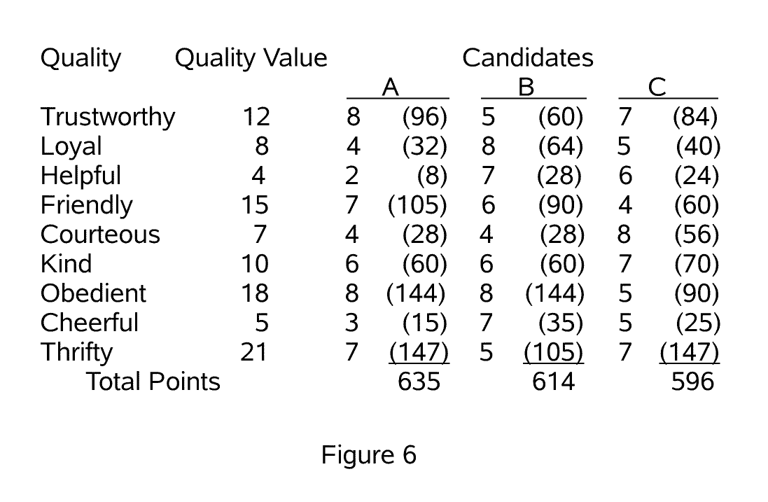

The data input by the participant is transformed to indicate overall perceived performance of each alternative. In one embodiment, the performance or possession rating values of the alternative are multiplied by the value of the qualities. The resulting values are summed for each alternative resulting in a single comparative score for each alternative. An example is shown in FIG. 6.

In embodiments using a stand-alone computer, the transformation of the data could be performed by stand-alone computer. In some embodiments using a stand-alone computer, the raw data is be transferred by the display, memory device, or by a wired or wireless connection to another computer where it is transformed.

In embodiments using a client-server system, the transformation of the data may be performed on either the client or the server computer. In embodiments using an internet based system, the transformation of the data could be performed on the internet accessible device or may be performed on the server.

Methods of further analyzing the data collected are numerous. Statistical and graphical tools may be applied to quantify and display much useful knowledge such as (but not limited to) which qualities are the most important and have the greatest impact on certain alternative. The data may be analyzed on the basis of time, demographics,

A poll may be restricted (FIG. 2, 130) to those participants specifically invited or the poll may be open to the public. Restricted participants could include those physically present such as in a room or encountered in a public place such as a mall. Restricted participants could include those invited by a postal mailing or an email invitation. In embodiments using an internet accessible device and server, such invitations may have a link to a website. Links to websites may optionally include password or other restrictions to access such as but not limited to being logged on to the corporate network or answering a question. The poll may be taken anonymously or may require the consumers or voters to identify themselves.

Polls open to the general public may utilize means to restrict the number of times a participant may participate in one or more polls (FIG. 2, 125). Such means could be based on such things as (but not be limited to) an IP address, a cookie, a Google mail address, a computer identifier such as a Windows license key, a hard drive identifier, a bio-metric scan or voice recognition system, an identity document swipe, or a RFID or other contactless tag.

Participants may be invited to retake the poll to track changes in their attitudes. The invitation to retake the poll may be made on a regular, scheduled basis such as once per week, month, or year. The invitation to retake the poll may be made at irregular times from expected events such as elections, consumer product conventions, or holidays, or unexpected events such as a political crisis, a natural disaster, or a newly introduced market changing new product.

Participants could be asked to retake the poll during one session to respond to stimuli presented during that session. Stimuli which would make changes in the participants attitude may be public events such as (but not limited to) a political debate or SuperBowl commercials, or stimuli provided by the pollster such as (but not limited to) a product with which to interact, a product advertisement, or a political commercial.

Further analysis of the data from multiple tests may show how perceptions of the alternative have changed, the values of the qualities have changed, what values and perceptions may be the most sensitive and easy to change.

In one embodiment, the subject of the poll is political elections. The participants are invited by an open invitation posted on sites such as Google.com, political parties websites, special interests websites, news oriented websites, etc. Multiple access control is done by either or a combination of IP address and email address. A list of qualities to be valued is presented and may optionally allow participants to add qualities to the list. The qualities are valued by allocating a set number of points (100 for example) between the values. The total number of points allocated is displayed along with the total yet to be allocated. The candidates to be evaluated may be preset or may be changed by, for example (but not limited to), use of text entry boxes, drop down boxes to select from a larger list, or other input or selection means. The candidates performance or possession of each the listed qualities is evaluated by assigning a number or letter within a given, defined range. For example (but limited to), a number between 1 and 10 with 1 being poor performance or possession and 10 being full performance or possession of the quality in question. The overall performance of each candidate may be calculated by summing the product of the quality value times the evaluated candidate performance of that quality. Stimuli such as (but not limited to) a political advertisement, a position statement, or commentary on an opponent may be presented at any time during the poll. The participant may be allowed to view his or her evaluation compared to other participants. The data may be analyzed by trend and demographics. The data may be correlated to events or stimuli experienced outside of the poll or during the poll.

Access to the data and analysis may be granted for a fee or for free. In one embodiment the data and analysis is provided for a fee for a period of time after which the fee decreases or becomes zero. For example, the data and analysis of a poll seeking to understand voter reaction to an event could be restricted for a number of days to customers who are willing to pay a fee. This time delay would give them time to prepare a response before the data and analysis became publicly known. In one embodiment, the polling data and analysis is made available as the poll is being taken.

In addition to basing the access fee on time, the fee could also be dependant on other variables such as (but not limited to) amount of analysis required, number or size of demographic divisions selected, and number of stimuli presented to the participants.

In another embodiment, the invention is licensed for use on a website for determining the values and opinions of the visitors to the website. For example, a woodworking tool manufacturer may run a poll on its website about what the customers value in a router table and how their product(s) address those values. The data may or may not be made immediately available to the participants or may be made available some time in the future.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A method for quantifying a participant's values and opinions comprising the steps of:
a. Presenting to the participant a plurality of qualities pertaining to a set of alternatives
b. Receiving and recording data indicating the importance of said qualities to the participant
c. Presenting one or more alternatives to the participant
d. Receiving and recording data indicating the participant's perception of the performance or possession of the qualities by the alternatives and
e. Transforming the data so as to quantitatively compare the alternatives.

2. A computer implemented method for quantifying a participant's values and opinions, the method comprising:
a. Presenting a list of qualities pertaining to a set of alternatives to the participant on a client computer
b. Receiving and recording data indicating the importance of said qualities to the participant
c. Presenting one or more alternatives to the participant on the client computer
d. Receiving and recording data indicating the participant's perception of the performance or possession of the qualities by the alternatives and
e. Transforming the data so as to quantitatively compare the alternatives on the client computer or a server computer.

3. An internet implemented method for quantifying a participant's values and opinions, the method comprising:
a. Presenting to the participant a plurality of qualities pertaining to a set of alternatives on an internet accessible device
b. Receiving and recording data indicating the importance of said qualities to the participant
c. Presenting one or more alternatives to the participant on an internet accessible device
d. Receiving and recording data indicating the participant's perception of the performance or possession of the qualities by the alternatives and
e. Transforming the data so as to quantitatively compare the alternatives on the internet accessible device or a server computer.

4. A computer implemented method for quantifying a participant's values and opinions, the method comprising:
a. Presenting to the participant a plurality of qualities pertaining to a set of alternatives on a stand-alone computer
b. Receiving and recording data indicating the importance of said qualities to the participant on the stand-alone computer
c. Presenting one or more alternatives to the participant on the stand-alone computer
d. Receiving and recording data indicating the participant's perception of the performance or possession of the qualities by the alternatives on the stand-alone computer and
e. Transforming the data so as to quantitatively compare the alternatives.

5. A computer readable media having computer readable instructions recorded thereon for quantifying a participant's values and opinions, the instructions comprising:
a. Instructions for presenting a plurality of qualities pertaining to a set of alternatives to the participant
b. Instructions for receiving and recording data indicating the importance of said qualities to the participant
c. Instructions for presenting one or more alternatives to the participant
d. Instructions for receiving and recording data indicating the participant's perception of the performance or possession of the qualities by the alternatives and
e. Instructions for transforming the data so as to quantitatively compare the alternatives.
